(19) United States
(12) Patent Application Publication
(10) Pub. No.: US 2003/0126016 A1
(43) Pub. Date: Jul. 3, 2003

(54) System and method for processing product orders placed through a network

(76) Inventor: Shintaro Asano, New Castle, NH (US)

Correspondence Address: Mintz, Levin, Cohn, Ferris,, Glovsky and Popeo, P.C., One Financial Center, Boston, MA, 02111, US

(21) Appl. No.: 10/206,788

(22) Filed: Jul. 26, 2002

Related U.S. Application Data
(63) Continuation-in-part of application No. 10/150,769, filed on May 17, 2002, now abandoned.
(60) Provisional application No. 60/308,201, filed on Jul. 27, 2001.

(51) Int. Cl. G06F 17/60

(52) U.S. Cl. 705/15

(57) ABSTRACT

The invention provides a communications system and method for receiving at a network computer system electronic information from a multiple of sites (consumers) on a communications network, such as the Internet, and formatting and transmitting the information from the network computer system over a telecommunications network using simple protocols to a selected site. The invention provides a communications system and method particularly suited for processing electronic consumer orders including receiving at a network computer system a multiple of electronic order messages placed by consumers through a communications network or the Internet and transmitting the order messages to a multiple of designated vendors that do not have network communication capabilities or Internet access. The communications system and method enable the designated vendors without access to the Internet to receive electronic orders from consumers.

### CLAIM OF PRIORITY TO PRIOR PATENT APPLICATIONS

The present application claims priority under 35 U.S.C. §119(e) to U.S. provisional patent application serial No. 60/308,201, filed on Jul. 27, 2001 and is a continuation-in-part of U.S. patent application Ser. No. 10/150,769, filed May 17, 2002, both of which are incorporated herein by reference.

### FIELD OF THE INVENTION

The invention is directed generally to a communications system and method for processing and delivering information in a network. More particularly, the invention is directed to a communications system and method for processing electronic product orders and messages placed by users through a computer or communications network and forwarding the product orders or messages to vendors or other parties using a telecommunications network and simple protocols.

### BACKGROUND OF THE INVENTION

With the rapid proliferation of personal computers and the widespread use of the Internet for commercial transactions, it has become very common to buy and sell products, such as books, by purely electronic methods. College students almost all use the Internet and a very high proportion of high-school students do as well, so that the percentage of the buying population that is likely to use the Internet for on-line purchases is large and growing rapidly. Likewise, most companies, except for the smallest, use computers and the Internet in their operations. An exception is the restaurant industry, in spite of its annual revenue of some $400 B, as reported by the National Restaurant Association. This very large and increasing revenue is believed to be due, at least in part, to a decrease in cooking at home caused by various long-term societal changes, such as the increase in two-employee families. More meals are thus eaten in restaurants, and a rapidly growing segment of the restaurant business consists of meals that are delivered or picked up by the consumer to be eaten at home.

Restaurant owners tend to be computer-averse, in part because most restaurants are quite small, and at present, takeout (sometimes called carryout) and delivery orders are for the most part still placed by telephone. This is labor-intensive and highly error-prone. Efforts to use fax machines to place telephone orders have not fared well. Further, because of the computer aversion of restaurant owners, the use of e-mail to place orders has not received wide spread adoption. In addition, the use of e-mail to place restaurant orders is not desirable because prompt reception of e-mails is not guaranteed, and constant monitoring of the e-mail-receiving terminal is required. E-mail and fax ordering systems also have the costly problem of having orders placed but not picked up or paid for, or orders placed in error.

An example of a prior-art system for processing restaurant orders is disclosed in U.S. Pat. No. 5,991,739. In this system, orders are placed by a consumer via the Internet with an “on-line ordering machine.” The online ordering machine receives orders and transmits the orders to the restaurants via fax or the Internet. Alternatively, the orders are converted into speech using a voice synthesizer and transmitted to the restaurant by telephone. The restaurant calls back to acknowledge the order, and the customer is notified that the order has been accepted. A person at the restaurant must answer each call and indicate whether the proposed payment method is acceptable and when the order will be ready. This system has a number of disadvantages, including the difficulty of understanding computer-generated voice messages, and the need to have an employee continuously available for answering the telephone. The fax version of this system suffers from the drawbacks discussed above, and the voice synthesizer version can be somewhat error prone and expensive depending on the quality of the speech conversion and voice synthesizer used.

Another prior-art system is described in U.S. Pat. No. 6,026,375. The system described in this patent is designed for orders from mobile customers, such as those driving in an automobile. The mobile customer uses a rather sophisticated computer system (Mobile Customer Premises Equipment, MCPE) on board, capable of contacting the service provider, a location-determining system (such as GPS), and a financial system for payment. When the order is received, the service provider (SP) selects a restaurant capable of completing the order at the time the customer is estimated to arrive. The SP informs the customer of the restaurant and quotes the price, making use of several databases. When the customer approves, the order is sent to the restaurant. In this mobile system, communication between the customers, the service provider, a financial system and the restaurant can be by cellular telephone, using voice-recognition equipment, and/or from a PC via the Internet. This system would be expected to have a very high error rate due to the use of voice recognition, and the system is designed for mobile customers, which represents only one part of the take-out ordering industry.

In view of the problems and drawbacks of the prior art systems, an object of the invention disclosed herein is to provide an on-line ordering system that overcomes the drawbacks discussed above, while allowing restaurant owners to take advantage of the ever-increasing use of the Internet.

### SUMMARY OF THE INVENTION

An improved order-processing system, as configured for takeout service from restaurants, comprises: (1) a computer with Internet access available to the consumer, (2) a server connected to the Internet that hosts a website at which consumers choose the restaurant and the food to be ordered and that also formats the data received from the consumer into a suitable form and transmits it to the restaurant as a text message, (4) a receiver, printer, and operating telephone at the restaurant, and an accessible data base of restaurant information. A very desirable addition would be a database for the accumulation of consumer information.

Embodiments of the invention are generally directed to a communications system and method for receiving at a network computer system information from a multiplicity of sites (consumers) on a communications network, such as the Internet, and formatting and transmitting the information from the central site over a second communications network to a multiplicity of designated sites that are not connected with the communications network or the Internet. More particularly, embodiments of the invention provide a communications system and method for processing electronically placed consumer orders including receiving at a network computer system electronically placed consumer orders placed by a multiplicity of consumers through the Internet and formatting and sending the product orders from the network computer system over a telecommunications network to a multiplicity of designated vendors that do not possess network communication with the Internet. The communications system and method of the invention thereby enable the designated vendors without access to the Internet to receive Internet electronic product orders from consumers.

In one aspect, the invention is directed to a method for processing a restaurant takeout order. The method includes receiving an electronic request to place a takeout order from a computer by a consumer over a first communications network, providing restaurant information to the consumer over the first communications network, receiving an electronic order from the consumer over the first communications network, formatting the electronic order into a text message in a form suitable for transmission over a second communications network, and transmitting the text message to a selected restaurant over the second communications network to place the takeout order with the selected restaurant.

The restaurant information can include a list of candidate restaurants and a menu associated with the selected restaurant. The first communications network can be the Internet, and the second communications network can be a telephone network. The method can further include locating a consumer profile for the consumer from one or more databases and updating the consumer profile based on information contained in the electronic order. The consumer profile can include credit card information for a credit card, and the method can include a step of authorizing use of the credit card before transferring the electronic order to the selected restaurant. The electronic order can be sent to the selected restaurant as a text message at a data rate between 1200 baud and 2400 baud inclusive. The method can further include receiving the text message at a receiver at the selected restaurant, receiving caller identification information prior to receiving the text message at the receiver, and controlling a switch in the receiver based on the caller identification information received. The method can further include printing the text message at the selected restaurant.

Another aspect of the invention is directed to a method of receiving an order in a text format from a network computer system over a telephone line. The method includes detecting an incoming call, receiving caller identification information for the incoming call, comparing the caller identification information with stored caller identification information corresponding to the network computer system to identify a match, receiving and printing the text message when a match is identified, and coupling the telephone line to a telephone to route the incoming call when a match is not identified.

The method can further include preventing connection of the telephone to the telephone line during receipt of the text message, detecting an off-hook condition of the telephone when a message is not being received, and coupling the telephone to the telephone line. The method can further include indicating receipt of an incoming text message by illuminating a light.

In still another aspect, the present invention is directed to a system for processing a restaurant takeout order. The system includes an input to receive an electronic order by a consumer over a first communications network, a first output to provide restaurant information to the consumer over the first communications network, a processor configured to format the electronic order into a text message in a form suitable for transmission over a second communications network, and a second output to provide the text message to a selected restaurant over the second communications network to place the takeout order with the selected restaurant.

The restaurant information can include a list of candidate restaurants and a menu associated with the selected restaurant. The first communications network can be the Internet, and the second communications network can be a telephone network. The system can be configured to send the text message to the selected restaurant at a data rate between 1200 baud and 2400 baud inclusive. The system can further include a receiver having an input coupled to the second communications network to receive the text message. The receiver can include a telephone line interface, a telephone output and a switch, coupled to the input, the telephone line interface and the output, to couple the input to one of the telephone line interface and the telephone output depending on caller identification information received by the receiver. The receiver can further include a printer coupled to the telephone line interface to print the text message.

Yet another aspect of the present invention is directed to a receiver for receiving an order in a text format from a network computer system over a telephone line. The receiver includes an input to couple to a telephone line to receive an incoming call, an output for connection to a telephone, a telephone line interface unit, a processor coupled to the telephone line interface unit, and a switch having an input coupled to the input of the receiver, a first output coupled to the telephone line interface unit, and a second output coupled to the output of the receiver, the switch being coupled to the processor to receive control signals to couple the input of the switch to one of the first output and the second output. The processor is configured to receive caller identification information from the telephone line interface unit and to control the switch based on the information received to route text messages received by the receiver to the processor.

The processor can be further configured to compare the caller identification information received with stored caller identification information, and if a match occurs, to configure the switch to couple the input of the switch to the first output of the switch. The receiver can further include a printer coupled to the processor, and the processor can be configured to receive a text message from the telephone line interface and to forward the text message to the printer for printing. The receiver can further include an annunciator coupled to the processor, and the processor can be configured to provide a signal to the annunciator to activate the annunciator when the receiver is receiving a text message.

### BRIEF DESCRIPTION OF THE DRAWINGS

For a better understanding of the present invention, reference is made to the drawings in which:

FIG. 1 is a functional block diagram illustrating a first embodiment of the communications system of the invention for processing a restaurant takeout order;

FIG. 2 is a functional block diagram of a receiver of the communications system of the first embodiment;

FIG. 3 is a flow diagram of a method for processing a restaurant takeout order at a network computer system; and

FIG. 4 is a flow diagram of a method for processing a restaurant takeout or delivery order at a restaurant.

### DETAILED DESCRIPTION OF THE INVENTION

For the sake of easy understanding of the invention, the below description is presented in the context of the ordering of food from restaurants for takeout (i.e., to be picked up by the consumer or delivered) in which the consumer places orders via the Internet, and in which the restaurants receive the orders via ordinary telephone lines. However, it should be understood that the invention is applicable to any situation in which vendors desire to provide rapid order fulfillment but are particularly sensitive to investment of resources in equipment or labor and do not have, or prefer not to use, an Internet-like facility for reception of orders. Examples of such possible additional applications include the purchase of (1) automobile parts by repair shops and office supplies by small businesses, of (2) groceries, of (3) gift items, and (4) for refill of drug prescriptions. Other possible applications for use of communications systems and methods of the present invention include directing e-mail messages for printing to a destination that does not have an Internet connection, but does have an existing telephone line. For order placement, embodiments of the present invention are particularly well-suited for applications, such as auto parts ordering, in which it is desirable to present the consumer with graphics (i.e., exploded views of complex parts and associated assembly) to assist the consumer in selecting a correct part. Also, the text messaging provisions of order placement are less error prone and much more reliable as compared with spoken orders, particularly when dealing with lengthy alphanumeric part numbers. Text messaging eliminates mistakes associated with conversing in noisy environment and/or conversing with persons whose ability to speak English is limited.

Embodiments of the invention described herein provide improved systems and methods for processing orders for delivery soon after order placement. More particularly, embodiments of the invention provide improved systems and methods for order placement by consumers using a communication system such as the Internet with vendors who do not make use of an Internet-type communication system but receive the order by telephone. This is done in such a way that the telephone is available for normal use except during very short intervals in which orders are actually being transmitted.

In one embodiment, a network computer system includes a server, operated by an order facilitation service company (“the Company”), that carries out the reception of the order from the consumer. The network computer system, which includes one or more microprocessors, also hosts a web site that includes one or more pages for a particular restaurant to be accessed by the consumer to see menus for the restaurant, and to make selections of items to be ordered. The network computer system transmits such orders to vendors, and consults databases that contain consumer information and restaurant information.

Each restaurant makes use of a receiver, generally provided by the Company and coupled to a telephone line at the restaurant's place of business, that receives telephone messages from the server, determines, for each message, whether it is an order or not, and outputs a printed copy of each order on a printer attached to the receiver. Telephone calls received by the receiver that are not orders from the server are not answered by the receiver, allowing a telephone, either connected to the phone line through the receiver or coupled directly to the telephone line to be used to take the telephone call.

The network computer system can also be used to transmit messages other than consumers' orders to a specific restaurant and/or restaurants. For example, the Company can transmit account information, statements, special offers, information about gift certificates bought by consumers, and other messages to vendors through the receivers.

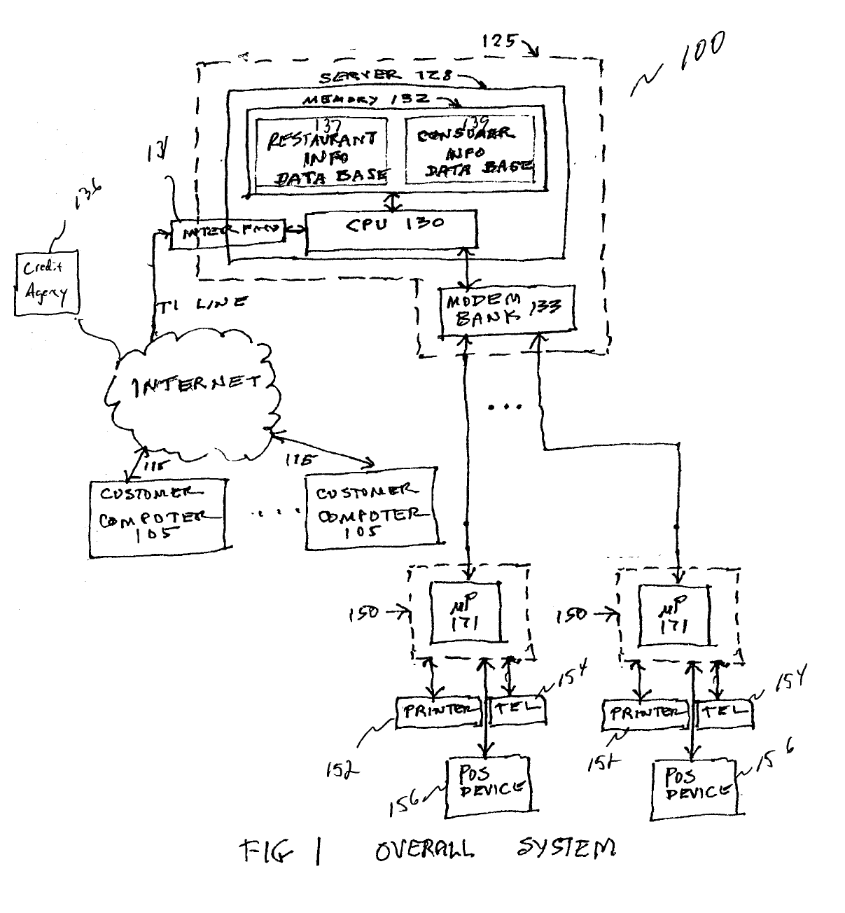

FIG. 1 shows a system 100 in accordance with one embodiment of the invention. The system includes a network computer system 125, receivers 150 and consumer computers 105 that access the network computer system over Internet connections 115. As shown in FIG. 1, in addition to the receiver 150, a vendor site may also include a printer 152, a telephone 154, and a point of sale device (POS) 156. The consumer computers 105 may use one of a number of known browsers to access the Internet using one of a number of known arrangements, such as dial-up, DSL, broadband cable, wireless, satellite, and a direct-wired connection.

The network computer system 125, operated by the Company, consists of a server 128, an Internet interface 131 and a modem bank 133. In one embodiment, the modem bank may be implemented using a Network Access Server available from Cisco. The server 128 includes a CPU 130 and memory 132 and hosts a website accessed by consumers to select restaurants and items desired therefrom. Memory 132 may include both hard disk drive(s) and RAM. The processing power of CPU 130 and the size of memory 132, both RAM and hard disks, that are needed depends on the amount of traffic to be handled.

In the system 100, customers access the network computer system over the Internet and customer choices are entered by filling in blanks on displayed pages as is well known in the art. The data entered is received by the network computer system, and formatted under control of server 128 into a serial text data stream, preferably in ASCII form, and is sent to a selected restaurant's receiver as previously mentioned. In embodiments of the invention, one of a number of known modulation methods may be used to transfer the data to the receiver, such as PSK or FSK. The use of multiple modems in the modem bank 133 allows transmission of simultaneous orders by multiple consumers by the system 100. To minimize the time needed to transmit an order from the network computer system to a receiver, a baud rate for transmission is used that is low enough to avoid the necessity of a lengthy handshake-and-equalize procedure and high enough to avoid telephone company signals, which may be transmitted at 1200 baud. In one embodiment, a baud rate of 2400 bits/sec is used, and at 2400 bits/sec, a typical order of 100 words is transmitted in one to two seconds. In one embodiment, the interface protocol for the transmission of data is the Zmodem interface protocol, and the modem setup procedure is a modified form of the CCITT v.22 bis standard. Specifically, when the receiver answers a call, it responds by sending a known CCITT v.22 bis answer tone. In response, the transmit modem is configured to send partial protocol information indicating that only 2400 is available for a data rate. When the receiver receives the partial protocol information, it sets the data rate for 2400, and data transmission to the receiver can begin.

As shown in FIG. 1, the memory 132 includes a restaurant information database 137 and a consumer information database 139. The restaurant information database contains the names, phone numbers, and menus, including prices, of the various restaurants. In one embodiment, server 128 provides for secured access by restaurants to update and otherwise edit data contained in the restaurant database. In another embodiment, updating the restaurant data may be performed by the Company. The data in the restaurant information database is used by server 128 in producing the pages viewed by consumers.

The consumer information database 139 includes information concerning consumers who use the network computer system 125. In embodiments of the invention, the ordering process is facilitated (and sales volume can be increased) by immediately recognizing repeat consumers, and automatically routing them to preferred restaurant sites, or providing them, for example, a list of previously accessed restaurant sites. The pattern of previous purchases can be used by the network computer system to propose items to be ordered, and a sign-in procedure can be greatly shortened using this data. Discounts can be given for “frequent eaters” or “loyal customers” and special offers made from time to time. Consumers can be offered passwords, and/or cookies can be placed in their computers to speed up the process. Data accumulated on consumers may well have sales value, for example to the vendors and/or large national manufacturers of various commodities. Databases 137 and 139 may be stored directly in the memory of the server, or alternatively may be located at remote sites, accessible by the server 128.

In one embodiment, server 128 is preferably also in electronic communication (for example, over the Internet, as shown in FIG. 1) with a credit authorization agency 136 such as CreditCardProcessor.com, so that consumers can prepay orders by credit card, and eliminate the effects of costly “no-shows” that plague the telephone-takeout industry. Consumers that do not wish to prepay can pay on delivery or pickup, if the restaurant is willing to use this method.

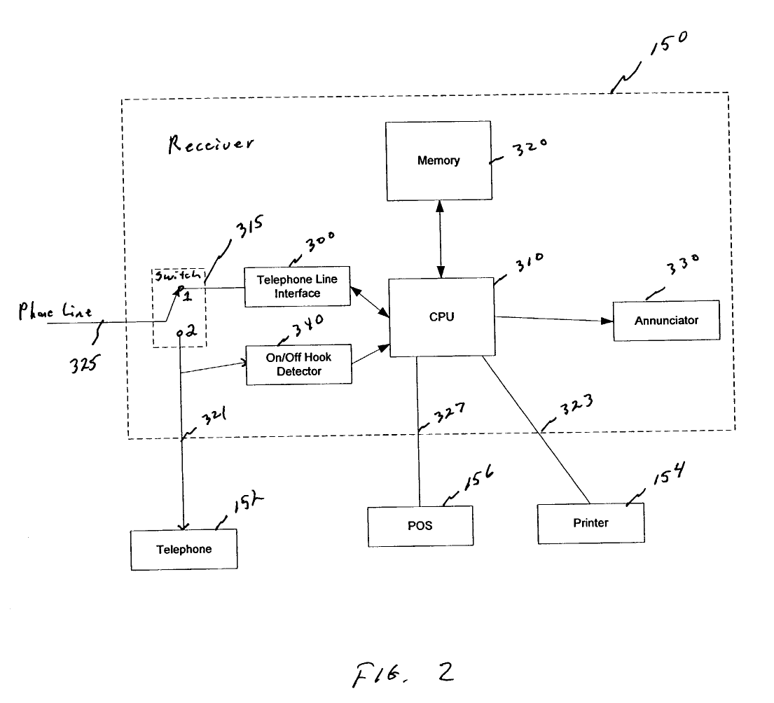

FIG. 2 is a block diagram of the receiver 150 in accordance with one embodiment of the invention. For ease of illustration, in the block diagram, signal connections between devices are shown as single lines. However, as is well known, the connection between devices may actually include a number of separate wires. For example, telephone connections are typically implemented using a pair of wires. The receiver 150 includes an optional switch 315 coupled to an input telephone line 325, a telephone line interface 300, an on/off hook detector 340, a CPU 310, memory 320, and an annunciator 330. The receiver also includes an interface 321 for the telephone 152, an interface 323 for the printer 154, and an interface 327 for the POS device 156. The operation of the receiver 150 is controlled by the CPU 310 using software contained in memory 320. In one embodiment of the present invention, the CPU is implemented using a Zilog eZ80 microprocessor, model no. eZ80190AZ050SC, available from Zilog of Campbell, Calif., and the telephone interface includes a Zilog Z02215 modem, model no. Z0221524ASCR50A5.

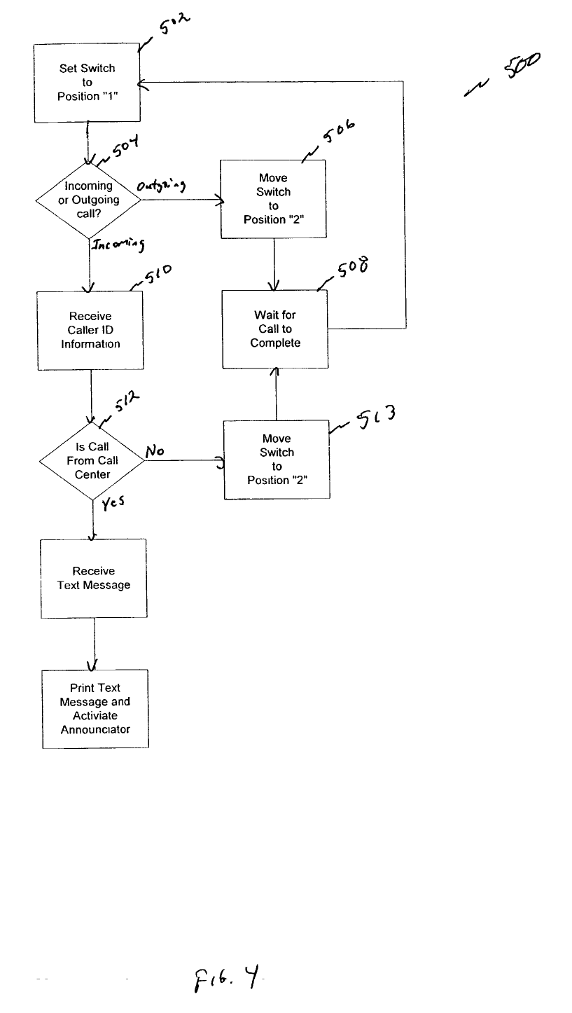

As is further explained below in greater detail with reference to FIG. 4, the CPU is configured to sense an incoming call from the network computer system 125, control the telephone line interface 300 to answer the call, receive a text message from the network computer system, print the text message on the printer, and in some embodiments actuate the annunciator, which may be implemented using a visible and/or an audible alarm. In one embodiment of the present invention, the CPU in conjunction with the telephone line interface uses caller ID to identify calls originating from the network computer system. In this embodiment, the telephone line interface 300 is normally connected to the telephone line by means of the switch 315 being in position 1. In this embodiment, the caller ID number or numbers for the network computer system are entered into the CPU. Upon receipt of each call, the CPU compares the caller ID information for the incoming call with the stored numbers. If the caller ID number matches a stored number, then the telephone line interface answers the call to receive the text message. If there is no match, the switch 315 is moved to the telephone position 2 to allow the telephone 152 to ring and receive a telephone call.

In one embodiment of the present invention, the CPU transmits data to the printer using RS232, and a thermal printer is used. In other embodiments, other printers and printer formats can be used. In addition, in one embodiment, the CPU is capable of transmitting data to the POS device using one of a number of known formats such as RS232, RS422 or RS485, and in some embodiments, the data may be sent in an encrypted form. Data that can be transferred to the POS device includes status information, text messages, sales data, as well as other data. In one embodiment of the present invention, the receiver and printer are incorporated into a POS device, and in addition, in one version, the telephone is incorporated in the POS device or connected through the POS device.

The switch 315 in the receiver is an optional device that is controlled by the CPU 310 to connect either the telephone or the receiver to the telephone line 325, in a procedure detailed in FIG. 4. The CPU utilizes the on/off hook detector to detect when a user lifts the telephone handset off the cradle to make a call, and places the switch in position 2 in the telephone position, provided no order is being received. Otherwise, the switch is maintained in position 1 coupled to the telephone line interface position to detect incoming calls, and is moved to position 2 when the CPU determines (after one ring when caller ID information is typically received) that an incoming call is not from the network computer system. The use of the switch prevents a restaurant employee from accidentally interfering with receipt of a text message by lifting the handset of the telephone during receipt of the text message.

In receivers that do not implement the optional switch, the telephone will ring once before caller ID information is received and the telephone line interface answers the call. In these embodiments, users should be trained to refrain from answering a call until after one ring to allow the telephone line interface to answer calls from the network computer system. Also, prior to making calls, in embodiments that do not implement the switch, users should check to see if the annunciator is lit indicating that the receiver is receiving a text message. In some embodiments multiple annunciators may be used to indicate different states of the system, such as “incoming message” and “message complete”.

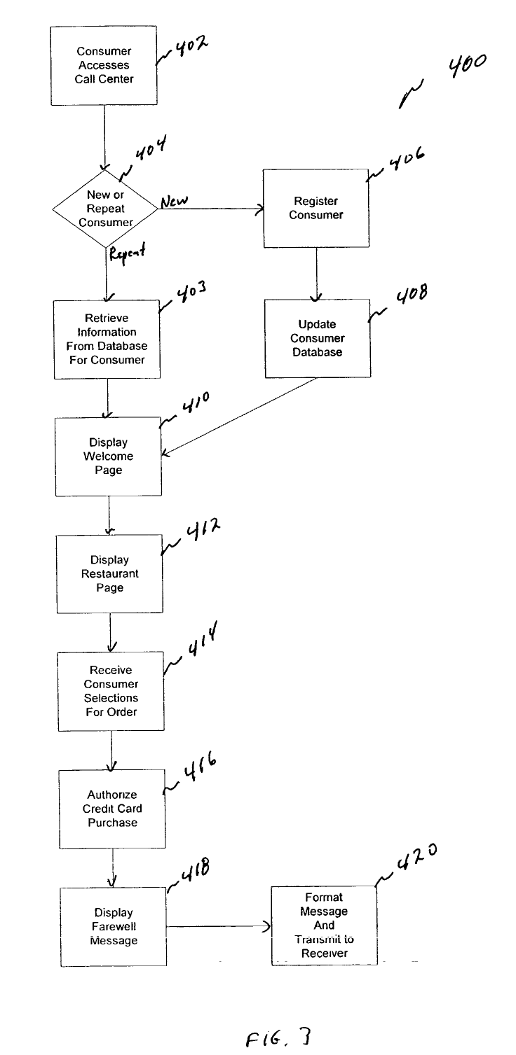

The operation of the system 100 will now be described with reference to FIGS. 3 and 4, which are respectively flow diagrams of the process 400 followed in the network computer system and the process 500 followed by the receiver. As shown in FIG. 3, at a first stage 402 of the process, a consumer accesses the network computer system 125 over the Internet from one of the customer computers 105. At stage 404, the network computer system determines whether the consumer is a new or repeat customer. If the consumer is new, then at stage 406, the consumer is registered with the system using a new-customer registration page, which asks for relevant information such as name, address, and phone number, and in some embodiments, credit card payment instructions are also requested. When credit card information is provided, a secure connection to the credit-card authorization agency is used for authentication. After registration information is received for the new consumer, then the consumer database is updated in step 408. In some embodiments, the consumer database can also be updated for repeat consumers, e.g., to keep track of ordering history, if desired. At stage 410, a welcome page is displayed to the consumer. The display of the welcome page may occur at the same time that the consumer database is updated. If desired, different welcome and restaurant pages may be displayed to first-time customers.

At stage 404, if the consumer is a repeat consumer, then process 400 proceeds to stage 403 where information for the consumer is retrieved from the consumer database. The process then proceeds to step 410 for the display of the welcome page. The welcome page that is displayed may be customized to include information contained in the consumer database for the consumer including any preferences selected by the consumer. The welcome page can include a listing of all restaurants in a zip code or city/town of the consumer with an indication of those that are registered member restaurants with the network computer system. In addition, the welcome page may display specials, coupons or other information, which may be particularly selected based on the consumer's profile. The consumer's profile can include information about the consumer, including preferences, address information, credit card information and ordering history information, as well as other information. From the welcome page, the consumer can select a restaurant, at which point, at stage 412, a restaurant information page is displayed to the consumer. At step 414, the consumer can select items to include in an order and in some cases indicate whether an order is for delivery or pick-up, and a total price for the order will be displayed. The consumer is then given the opportunity to confirm the order, and after the consumer is satisfied, the credit-card authorization agency is again contacted via a secure connection in stage 416 to authorize a credit card purchase. In embodiments of the present invention, it is desirable that purchases be made using credit cards to prevent fraudulent orders. However, embodiments of the present invention are not limited to credit card payments, and systems and methods of the invention may be used with consumers that chose to pay upon pick-up or delivery of an order, provided that the restaurant agrees.

After the order has been confirmed, and the credit card authorization process has been completed, then at stage 418, a farewell message is displayed. Next, at stage 420, the network computer system formats the order data into a text message for transmission to the vendor or restaurant chosen by the consumer. At stage 420, the telephone number of the selected restaurant is then retrieved from the restaurant information database, and the selected restaurant is then called using the modem bank and a text message containing the order, delivery instructions (if any) and payment information is sent to the selected restaurant. If the telephone line for the restaurant is busy, then the network computer system will retry calling for a predetermined number of times, and if finally unable to complete the call, will indicate to the consumer, via e-mail or the Internet, that the order was not able to be placed.

In one embodiment, a confirmation message can be sent to the consumer by the network computer system at this point via the website or by e-mail. In other embodiments, the receiver can send a confirmation message to the network computer system indicating that the message was received and printed, and this confirmation message can be sent to the consumer. In one embodiment, if a confirmation message is not received by the network computer system from the receiver, then the network computer system will resend the order. In this case, the network computer system may add an additional text line indicating that this is a duplicate order to prevent two orders from being placed.

In embodiments described above, particular pages with particular types of information are described as being displayed. As understood by those skilled in the art, the particular order of display and the information displayed may vary in different embodiments of the invention.

The operation of a process 500 in the receiver for receiving text messages in accordance with one embodiment of the invention will now be explained with reference to FIG. 4. At stage 502, initially the switch in the receiver is set to the “1” position, with the telephone line interface coupled to the input telephone line, and the telephone disconnected from the input telephone line. The process continues to stage 504, where the process waits for either an incoming call to be received, or indication that the handset has been lifted from the telephone, indicating that a user has lifted the handset of the telephone attached to the receiver to make an outgoing telephone call

When the handset is lifted by a user, the process will move to stage 506, where the switch is moved from position “1” to position “2” to enable the user to make a telephone call. The process moves to stage 508 and waits until the call is finished by detecting that the handset has been set back into the cradle of the handset. Once the call is finished, then the process returns to stage 502.

When an incoming call is received while the process is at stage 502, then the process proceeds to stage 510, where the caller ID information is retrieved. Caller ID information is typically sent in telephone networks between the first and the second rings. At stage 512, the caller ID information is compared with known information for the network computer system to determine if the incoming call is an order from the network computer system. If the outcome of stage 512 is “NO”, then the switch is moved to position “2” at stage 513, and the telephone connected to the receiver will begin ringing with the second ring. The switch will remain in position “2” until the call is completed, and the process returns to stage 502. If the outcome of stage 512 is “YES”, then the CPU receives the text data at stage 514 and prints and announces the data at step 516. The process then returns to stage 502. In one embodiment of the present invention, the switch is controlled by the CPU such that it will not move to position “2” if the handset is lifted while an incoming call text message being received.

In embodiments described above, the receiver includes a switch that under the control of the CPU positively keeps the telephone line connected to the incoming telephone line interface to prevent the user from making a call while data is being received, and to allow a first ring of an incoming call to be suppressed while the CPU determines if the incoming call is from the network computer system. In other embodiments, the receiver does not contain the switch, and for these embodiments, employees of the restaurant are trained to wait until after one ring prior to answering a call and to ensure that data is not being received (by looking at the annunciator light) prior to lifting the handset to make a call.

The use of the switch in the receiver is particularly beneficial for small restaurants that have only one incoming telephone line that is used for both traditional telephone orders and for telephone orders from the network computer system. For busy restaurant locations having more than one incoming telephone line, it may be desirable to use a dedicated telephone for the receiver.

Embodiments of the present invention discussed above utilize a printer to print orders for vendors, such as a take-out restaurant. In other embodiments, the orders may also be printed on a printer and/or entered into a point of sale device coupled to the receiver. In still other embodiments, in addition to sending an order to a selected restaurant, the network computer system can also send a similar message to a third party delivery service indicating that a particular order is to be delivered from the restaurant to the consumer.

Embodiments of the present invention have been described above for use with ordering systems. Other embodiments of the present invention are useful for other applications as well. In one embodiment, a central e-mail server can be used to distribute emails for printing at sites that do not have Internet access. In one such embodiment, a user of an Internet access device (which includes computers, personal digital assistants, and wireless internet access devices) can forward e-mails for printing through a network computer system that converts the e-mail to a text message and sends the text message to a receiver having a printer like the receiver described above. As in the embodiments discussed above, the receiver can be programmed to detect that an incoming call is from the network computer system, and can direct the text message for printing. Using this embodiment, a user, for example, when out of the office, can choose to have all e-mails forwarded to home for printing, and can still receive all e-mails without having Internet access. The selectivity provided by the switch in the receiver allows a user to receive e-mails at home without using a dedicated telephone line and without significant interference with other calls (incoming or outgoing) on the telephone line.

In embodiments described above, orders are printed as they are received. In other embodiments, orders may be stored in the memory of the receiver until it is desired for them to be printed. In these embodiments, the receiver may include a display indicating how many orders are stored in the receiver. In still another embodiment, a display on the printer may be used in place of or in addition to the printer to display the text messages received.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A method for processing a restaurant takeout order, comprising:
receiving an electronic request to place a takeout order from a computer by a consumer over a first communications network;
providing restaurant information to the consumer over the first communications network;
receiving an electronic order from the consumer over the first communications network;
formatting the electronic order into a text message in a form suitable for transmission over a second communications network; and
transmitting the text message to a selected restaurant over the second communications network to place the takeout order with the selected restaurant.

2. The method of claim 1, wherein the restaurant information includes a list of candidate restaurants and a menu associated with the selected restaurant.

3. The method of claim 2, wherein the first communications network is the Internet.

4. The method of claim 3, wherein the second communications network is a telephone network.

5. The method of claim 4, further comprising locating a consumer profile for the consumer from one or more databases.

6. The method of claim 5, further comprising updating the consumer profile based on information contained in the electronic order.

7. The method of claim 6, wherein the consumer profile includes credit card information for a credit card, and the method includes a step of authorizing use of the credit card before transferring the electronic order to the selected restaurant.

8. The method of claim 7, wherein the electronic order is sent to the selected restaurant at a data rate between 1200 baud and 2400 baud inclusive.

9. The method of claim 1, further comprising receiving the text message at a receiver at the selected restaurant

10. The method of claim 9, further comprising receiving caller identification information prior to receiving the text message at the receiver, and controlling a switch in the receiver based on the caller identification information received.

11. The method of claim 10, further comprising printing the text message at the selected restaurant.

12. The method of claim 1, wherein the restaurant information includes information related to a plurality of restaurants.

14. The method of claim 1, further comprising locating a consumer profile for the consumer from one or more databases.

15. The method of claim 14, further comprising updating the consumer profile based on information contained in the electronic order.

16. The method of claim 15, wherein the consumer profile includes credit card information for a credit card, and the method includes a step of authorizing use of the credit card before transferring the order to the selected restaurant.

17. A method of receiving an order in a text format from a network computer system over a telephone line, comprising:
detecting an incoming call;
receiving caller identification information for the incoming call;
comparing the caller identification information with stored caller identification information corresponding to the network computer system to identify a match;
receiving and printing the text message when a match is identified; and
coupling the telephone line to a telephone to route the incoming call to the telephone when a match is not identified.

18. The method of claim 17, further comprising preventing connection of the telephone to the telephone line during receipt of the text message.

19. The method of claim 18, further comprising detecting an off-hook condition of the telephone, and coupling the telephone to the telephone line.

20. The method of claim 19, further comprising indicating receipt of an incoming text message.

21. The message of claim 20, wherein indicating receipt includes illuminating a light.

22. A system for processing a restaurant takeout order, comprising:
an input to receive an electronic order by a consumer over a first communications network;
a first output to provide restaurant information to the consumer over the first communications network;
a processor configured to format the electronic order into a text message in a form suitable for transmission over a second communications network; and
a second output to provide the text message to a selected restaurant over the second communications network to place the takeout order with the selected restaurant.

23. The system of claim 22, wherein the restaurant information includes a list of candidate restaurants and a menu associated with the selected restaurant.

24. The system of claim 23, wherein the first communications network is the Internet.

25. The system of claim 24, wherein the second communications network is a telephone network.

26. The system of claim 25, wherein the system is configured to send the text message to the selected restaurant at a data rate between 1200 baud and 2400 baud inclusive.

27. The system of claim 22, further comprising a receiver having an input coupled to the second communications network to receive the text message.

28. The system of claim 27, wherein the receiver includes a telephone line interface, a telephone output and a switch, coupled to the input, the telephone line interface and the output, to couple the input to one of the telephone line interface and the telephone output depending on caller identification information received by the receiver.

29. The system of claim 28, wherein the receiver further includes a printer coupled to the telephone line interface to print the text message.

30. The method of claim 22, wherein the restaurant information includes information related to a plurality of restaurants.

31. A receiver for receiving an order in a text format from a network computer system over a telephone line, comprising:
an input to couple to a telephone line to receive an incoming call;
an output for connection to a telephone;
a telephone line interface unit;
a processor coupled to the telephone line interface unit; and
a switch having an input coupled to the input of the receiver, a first output coupled to the telephone line interface unit, and a second output coupled to the output of the receiver, the switch being coupled to the processor to receive control signals to couple the input of the switch to one of the first output and the second output;
wherein the processor is configured to receive caller identification information from the telephone line interface unit and to control the switch based on the information received to route text messages received by the receiver to the processor.

32. The receiver of claim 31, wherein the processor is configured to compare the caller identification information received with stored caller identification information, and if a match occurs, to configure the switch to couple the input of the switch to the first output of the switch.

33. The receiver of claim 32, further comprising a printer coupled to the processor, and wherein the processor is configured to receive a text message from the telephone line interface and to forward the text message to the printer for printing.

34. The receiver of claim 33, further comprising an annunciator coupled to the processor, and wherein the processor is configured to provide a signal to the annunciator to activate the annunciator when the receiver is receiving a text message.

35. The receiver of claim 31, further comprising a printer coupled to the processor, and wherein the processor is configured to receive a text message from the telephone line interface and to forward the text message to the printer for printing.

36. The receiver of claim 31, further comprising an annunciator coupled to the processor, and wherein the processor is configured to provide a signal to the annunciator to activate the annunciator when the receiver is receiving a text message.
